(19) United States
(12) Patent Application Publication
(10) Pub. No.: US 2004/0225609 A1
(43) Pub. Date: Nov. 11, 2004

(54) Electronic bill presentation and payment system

(76) Inventor: Andrew Greene, Jericho, NY (US)

Correspondence Address: PILLSBURY WINTHROP, LLP, P.O. BOX 10500, MCLEAN, VA, 22102, US

(21) Appl. No.: 10/799,390

(22) Filed: Mar. 12, 2004

Related U.S. Application Data
(60) Provisional application No. 60/454,585, filed on Mar. 13, 2003.

(51) Int. Cl. G06F 17/60

(52) U.S. Cl. 705/40; 705/35

(57) ABSTRACT

An electronic bill presentation and payment (EBPP) system and a method to use the same with application both in the business-to-consumer and business-to-business transactions. The system enables a user of the system to specify a preferred financial institution for paying the consumer bills, and particular biller with which the user consumer does business, allowing both to be accessible on a single Web site. The information regarding the consumer's finances and the consumer's purchases from particular billers need not be shared between the financial institution and the billing company, thus providing improved security and consumer privacy. The look and feel of a singular presentation of financial institution information, biller information, and presenter information on a single page is provided by an advantageous use of Flash X technology which permits the presentation of information from the processor's centralized data base of is acquired data from the servers of both the financial institution and billing companies through extraction, transforming and loading (ETL) techniques.

### FIELD OF INVENTION

The present invention is directed toward an electronic bill presentation and payment system and, more particularly, to an electronic bill presentation and payment system in which a payer has access to one or more financial institutions information and one or more billing companies information and billing data through a single Web site.

### BACKGROUND OF INVENTION

Electronic bill presentation and payment (“EBPP”) has emerged as a strategic differentiator in highly competitive markets. Besides providing convenient access to billing information, electronic payment by customers saves them stationery and postage costs. The electronic environment also enables business partners to reduce the cost of processing paper bills and statements by making it easier to use electronic workflow processes. In addition, electronic billing improves cash flow by increasing the speed and accuracy of payments for goods and services between organizations. Furthermore, electronic billing information and data through a single Web site allows billing companies and banks to improve and enhance their relationship to their customers.

There are presently four primary models for implementing EBPP: the billing company direct model; desktop consolidator model; thick consolidator model, and thin consolidator model. The billing company direct model supports a single billing company's EBPP requirements. This approach increases the billing company's control of the entire process, enables the billing company to customize the Web experience for consumers, and provides complete control over marketing messages. A disadvantage of the direct model is it is not easy to navigate and it does not provide a convenient mechanism for consumers to view statements and pay bills for multiple billing companies.

The desktop consolidator model aims to combine the benefits of bill consolidation for customers and consumer interaction for billing companies. This model may be implemented through Web browsers, e-mail, or proprietary PC software. Consumer acceptance of this model, however, has been limited because of the need to install additional software on client computers.

Using the thick consolidator model a consumer receives all statement and billing details in both summaries and detailed formats. The presentation is integrated with a bill payment process and the consumer relationship is managed at the consolidator Web site. Using the thin consolidator model a consumer receives a summary statement and billing information for a number of different billing companies. This model can be integrated with a bill payment process to authorize payments. A disadvantage of both the current thick and thin consolidator models is that to view a statement or billing detail, consumers must click a link to the originating billing company's Web site and are either redirected to the originating billing company's Web site or the billing details is “screen scraped” back to the consolidator site or the originating billing company's information is scanned from its printed for republication on the consolidator site.

There is a need for an EBPP system that does not have the limitations of the prior art systems. That is, there is a need for an EBPP system that supports a consolidator model that does not require payers to link with billing companies' Web sites for paying bills or screen scraping billing details back to a consolidator site, as disclosed below in the embodiments of the present invention.

### SUMMARY OF INVENTION

The present invention discloses a unique EBPP system which consolidates in a centralized data base, informational data acquired from the servers of financial institutions and billing companies through extraction, transforming and loading “ELT”) techniques, and which, at the same time, allows the users of the system to communicate with their financial institutions and billing companies in a manner such that information regarding the users' finances and the users' purchases from particular billers need not be shared between the financial institutions and the billing companies. One aspect of an embodiment of the present invention provides improved security for both the financial institutions and billing companies as well as the user consumer's data and improved consumer-desired privacy. Such segregation capability further provides financial institutions and billing companies the ability to increase their interaction with and access to their consumers while maintaining a more exacting control over their consumer relationships.

In another aspect of an embodiment, the EBPP of the present invention enables a consumer to specify a preferred financial institution for paying the consumer bills, and particular billers with which the consumer does business, allowing both to be accessible on single Web site. In another aspect, the EBPP system of the present invention enables the financial institution and billing company to present targeted product and/or services promotional material outside of that necessary for consummating the desired bill payment transaction. The look and feel of a singular presentation of financial institution information, biller information, and presenter information on a single page is provided by an advantageous use of Flash X technology which permits the presentation of information from the processor's centralized data base of acquired data from the servers of both the financial institution and billing companies through extraction, transforming and loading (ETL) techniques.

More specifically, an embodiment of the present invention involves a system for electronic bill presentation and payment (“EBPP”). The system comprises a memory for storing Web pages for an EBPP Web site, and a processor in communication with the memory. The processor operates to receive an EBPP user interface (“UI”) from an EBPP host. The UI is configured to display financial institution information in a first portion of the UI, billing party information in a second portion, and billing data information in a third portion of the UI. The processor receives the financial institution information for display in the first portion of the UI, and transmits a request for the billing party information and billing data. The processor then receives the billing party information for display in the second portion of the UI and the billing data identifying one or more bills for display in the third portion of the UI. The system transmits instructions to the EBPP host to pay one or more bills of the billing party, and subsequently, relays payment information to the billing company.

Another embodiment of the present invention discloses a method for utilizing an electronic bill presentation and payment (“EBPP”) system. The method involves receiving an EBPP user interface (“UI”) from an EBPP host. The UI is configured to display financial institution information in a first portion of the UI, billing party information in a second portion of the UI, and display billing data information in a third portion of the UI. The system receives the financial institution information for display in the first portion of the UI, and transmits a request for the billing party information and billing data information. The system receives the billing party information for display in the second portion of the UI and the billing data identifying one or more bills for display in the third portion of the UI. The system then transmits instructions to the EBPP host to pay one or more bills of the billing party. The method further involves relaying the payment information back to the billing company or bank.

### BRIEF DESCRIPTION OF DRAWINGS

A more complete appreciation of the invention and the advantages thereof will be more readily apparent by reference to the detailed description of the preferred embodiments when considered in connection with the accompanying figures, wherein:

FIG. 1 is an overview of an exemplary system for implementing the present invention;

FIG. 2 is a general flow chart of an exemplary method of the present invention;

FIG. 3 is a detailed flow chart of an exemplary method of the present invention;

FIG. 4 is a detailed flow chart, extending from FIG. 3, of an exemplary method of the present invention;

FIGS. 5a-5b are exemplary screen shots of screens viewed by a user prior to logging onto a system of the present invention;

FIGS. 6a-6b are exemplary screen shots of an opening screen viewed by a user after logging onto the system;

FIGS. 7a-7d are exemplary screen shots of a “view statements” screen;

FIG. 8 is an exemplary screen shot of a “move funds” screen;

FIGS. 9a-9c are exemplary screen shots of a “pay bills” screen, wherein a user may view all paid bills, bills to pay, and scheduled;

FIGS. 10a-10b are exemplary screen shots of a “pay bills” screen, wherein a user may transfer funds into an account determined to have deficient funds; and

FIG. 11 is an exemplary screen shot of a “pay bills” screen, wherein a user accesses information and billing data from a particular billing company's Web site.

In the figures, off-page references are used to refer the reader to figures that continue on another drawing page. The references include two parts: an off-page reference letter and a figure number in which the figure continues or from which the figure is continued. An example of an off-page reference is “A/4”, where “A” is the off-page reference letter and 4 is the drawing page on which the figure continues or from which the figure is continued.

All product, service, or company trade names mentioned herein or shown in the Figures are used only to facilitate descriptions of preferred embodiments of the present invention and are the property of their respective owners. Use of the trade names is not intended to express any owner's endorsement of the present invention.

### DETAILED DESCRIPTION

The inventors have developed a system that includes a consolidator interface technology that provides seamless, transparent, comprehensive, secure and easy to use solution for electronic bill presentation and payment (“EBPP”). Payers that use the disclosed EBPP system will have a central location where they may receive and analyze all of their electronically presented bills, invoices, and statements, and have payments made to billing companies via the payers preferred financial institution.

The system allows individual financial institutions the ability to private label their own consolidator application enabling them to maintain control over their consumer relationships without the consumer knowing they are utilizing the system. Furthermore, the system offers billing companies (described alternatively as “billers” herein) the same control over their bill and pay transactions as if the EBPP system was running on their own premises. With tight integration to both sides of the buy/sell transaction, the system allows billers and payers to control as much of the process as they desire.

The EBPP system includes business-to-business (“B2B”) components and business-to-consumer (“B2C”) components; however, general operation of the system is common to both businesses and consumers. As disclosed in more detail herein below, the system is automatically configured when the user (the term “payer” is used interchangeably with the term “user”), be it a business or a consumer, logs into the system.

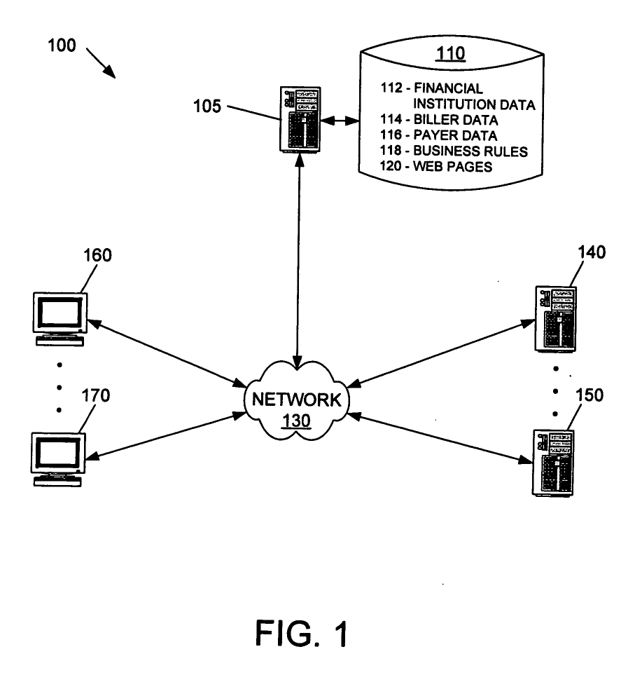

Referring to FIG. 1, there is shown an overview of an exemplary system 100 for implementing the present invention. The system 100 may include a server 105, which may be the server of an EBPP host that provides EBPP services to business and consumer system users. The server 105 includes a storage medium 110 that may store financial institution data 112, biller data 114, payer data 116, business rules 118, and EBPP Web pages 120. The server 105 may be in communication with other servers 140-150 (representing one or more servers) via a network 130 such as an intranet or the Internet. Such servers 140-150 may be those of financial institutions and billers. The computer system 100 further includes client computers 160-170 (representing one or more client computers) in communication with the server 105 via the network 130. Those of ordinary skill in the art will appreciate the various types of computers and configurations that the computers and the system may employ to facilitate embodiments of the present the invention.

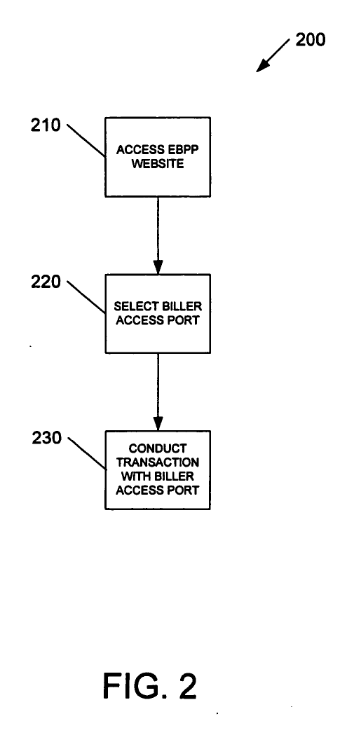

Referring to FIG. 2, there is shown a general flow chart 200 of an exemplary method of the present invention. At step 210 of the exemplary method a user accesses an EBPP Web site configured in accordance with the present invention as described in more detail herein below. Generally, a screen is displayed to the user that includes identification information of a financial institution previously designated by the user, biller, and a central ledger area. At step 220, the user may select a biller by clicking the biller's link, at which time outstanding bills are presented to the user for payment. From the user's point of view it appears that he is accessing the billers Web site for paying bills. At step 230, the user conducts a transaction with the selected biller by, for example, selecting a bill to be paid and confirming the payment transaction. Various other functions and attributes may be provided by the present invention as described in more detail herein below.

It is notable that although the term “financial institution” account is used herein, any type account may be used by a payer to pay bills.

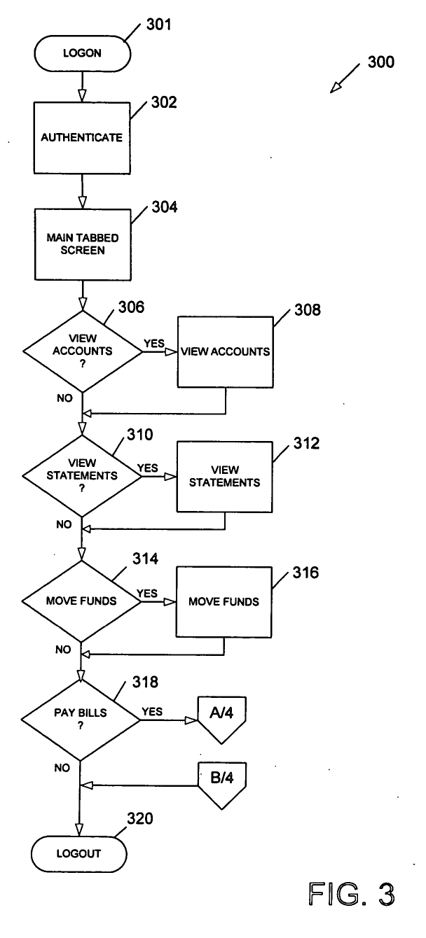

Referring to FIG. 3, there is shown a flow diagram 300 for describing the operation of the system of the present invention. Reference will be made to the screen shots shown in FIGS. 511 to facilitate in a better understanding of the invention.

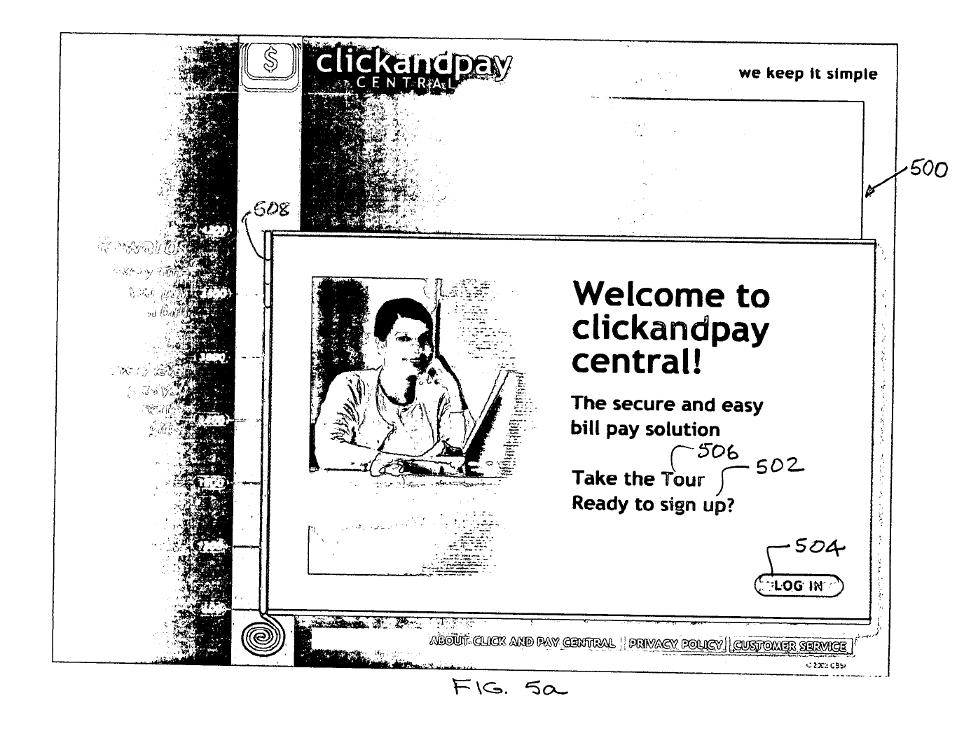

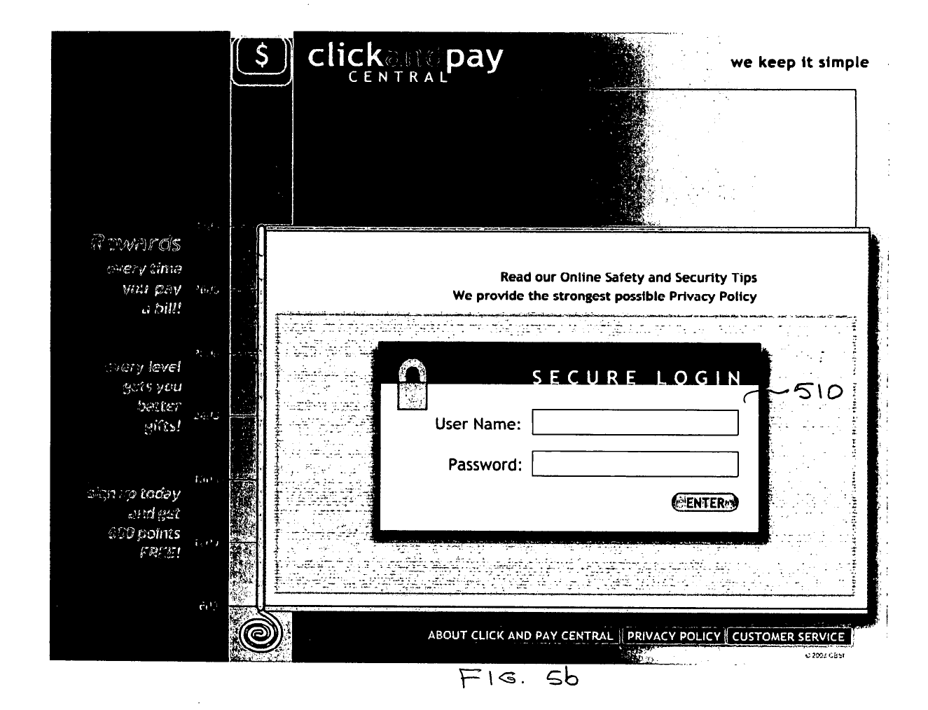

At step 301, initially a user may gain access to the site by entering the uniform record locator (“URL”) of the EBPP systems Web site into their web browser. A screen such as welcome screen 500 shown in FIG. 5a may be displayed inviting the user to sign up for the EBPP service. The welcome screen 500 may include a “ready to sign up” button 502 and a log-in button 504 for gaining access to the system. The user may also choose take a tour 506 to get a pre-view of the system offerings. The welcome screen 500 may also include a rewards “thermometer” 508, which, once the user has logged onto the system and the user's account information has been retrieved, indicates the amount of rewards points the user has accumulated by carrying out various activities in the system (e.g., pay a bill). For the user's convenience, the rewards “thermometer” may be included in every screen viewed by the user. Once the user clicks on the “log in” button, the user is presented by a secure login box 510 shown in FIG. 5b.

It is notable that the system may employ multiple security gates including, for example, a software password request (a middleware gate), a physical firewall, stored encryption at the database level, operating system gates (e.g., timeouts), dragons, and third party vendor review/testing (e.g., RipTech).

If the user had not previously signed up then he would click on the “ready to sign up” button 502 and follow the instructions for obtaining a password. The user would provide the system such information as the user's frill name, e-mail address, user name, and a bank account profile (e.g., bank account name, type, customer number). Thereafter, the user would receive an e-mail identifying a password. Once the user receives a password then the user will click on the log-in button 504 and enter the user's user name and password. At step 302, the system authenticates the user's user name and password.

If the user signs on through his financial institution, such as a bank, the sign on information appears to be on the bank site. In actuality, the user clicks on the bank icon that brings up the EPBB system application, which in turn presents to the user a page fully branded as the look-alike bank site.

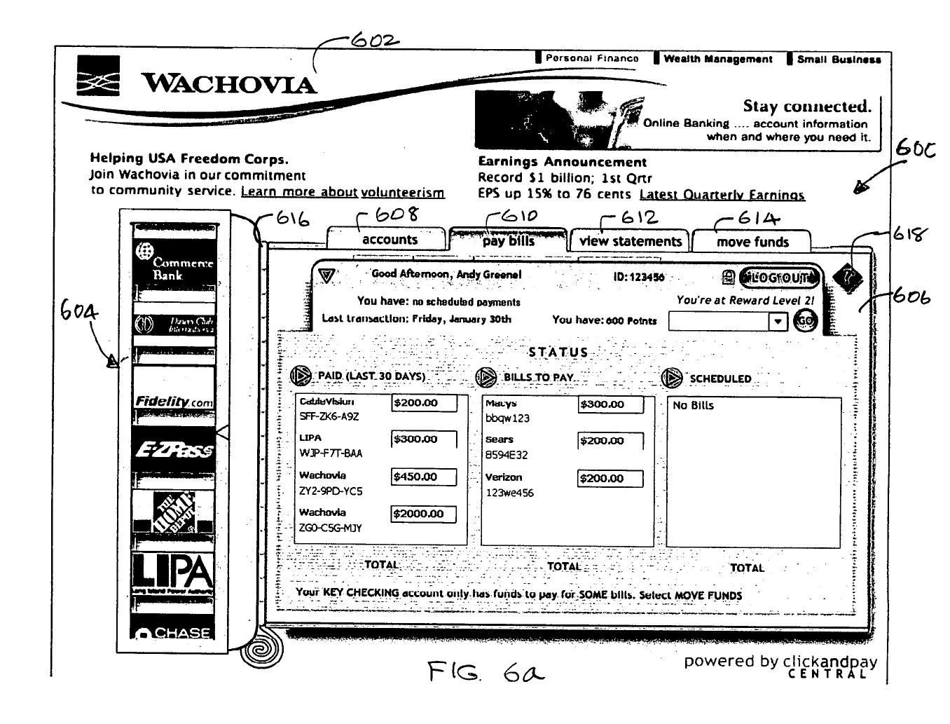

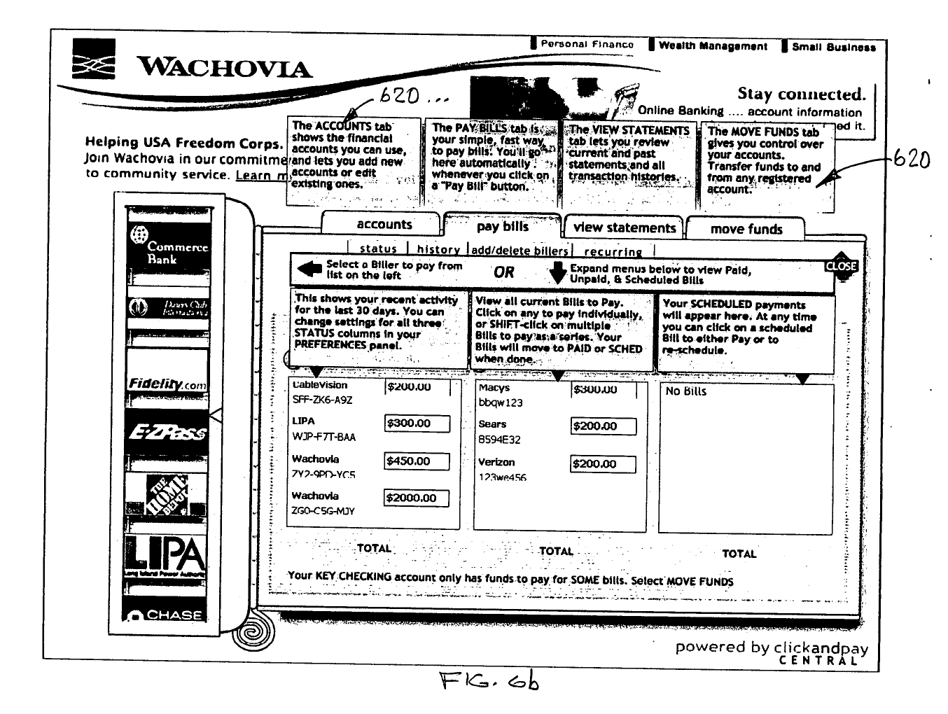

At step 304, a main screen such as the main screen 600 shown in FIG. 6a is displayed. It is notable that the main screen 600 and subsequent screens received by the user are tailored to the particular user logged onto the system. For example, the financial institution and billers that are displayed throughout any session are those previously identified by the particular user logged on. Furthermore, product/service offerings by the financial institution may be tailored to the user based on the user's economic profile and product/service offerings by billers may be tailored to the user based on the user's prior purchasing habits across all billing companies and bank transactions.

The upper portion 602 of the main screen 600 includes identification indicia (e.g., branding information, marketing promotions, links, messages) of the user's preferred financial institution, the left-hand portion 604 includes scrollable biller icons, and central portion 606 of the main screen may include various user functions and information related thereto headed by tab buttons entitled “accounts” 608, “pay bills” 610, “view statements” 612, and “move funds” 614. The main screen 600 also indicates when the user had his last transaction (e.g., Friday, January 30th), identifies how many bills are scheduled for payment this week, and indicates the number of member points the user earned. The main screen 600 also includes a rewards “thermometer” 616, which shows the number of member points the user earned. An online help button 618 is always available. Each one of the tab buttons shown in FIG. 6a are expandable with a click of the button to provide more explanation for the corresponding button, as referenced in general with numeral 620 in FIG. 6b.

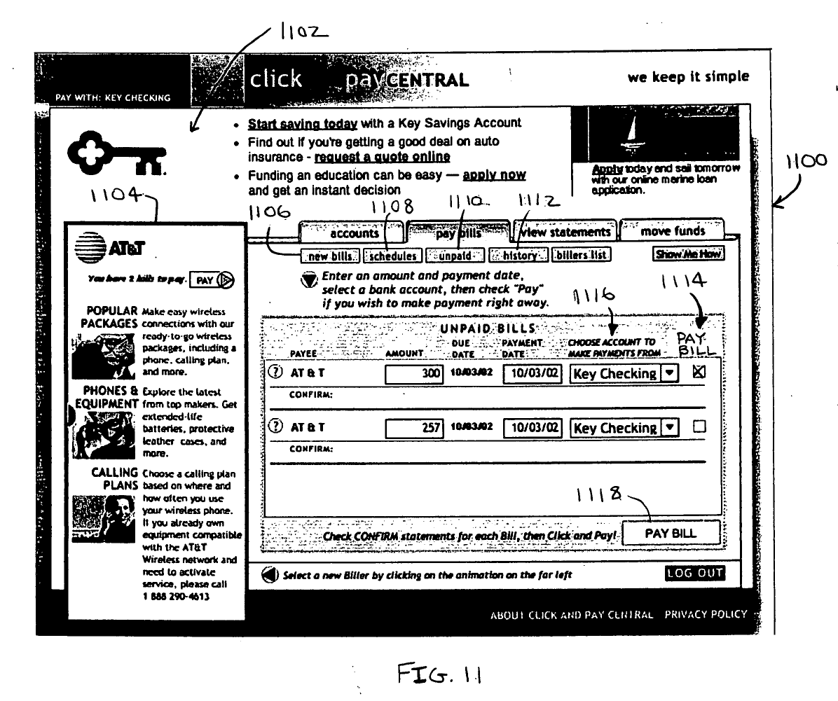

Those of ordinary skill in the art will appreciate that the Web's request and response model is inherently ill-suited for real-time data updating because hyper text markup language (“HTML”) pages have to reload in full every time a browser checks for new data on a server. To overcome this inherent disadvantage, the inventors make use of Flash MX, an Internet content and applications development tool by Macromedia, Inc. (San Francisco, Calif.). As a consequence, for example, with Flash MX, and other Macromedia platforms, the user interface 1100 shown in FIG. 11 may be configured to include a shell (e.g., the ClickandPay Central screen) into which is integrated in the upper portion of the screen 1102 (the branding skin area) Web data provided and controlled by a financial institution, and integrated into the left-hand and central portion of the screen 1104 Web data provided and controlled by a biller. The host provider information (e.g., ClickandPay Central information) is dimmed in order to accentuate the default financial institution (e.g., Key Bank). All attributes (described herein below) regarding the sell sheet area are applicable to the skin area. The central portion, or ledger area, includes a hot zone in which all interactivity takes place. For example, if a user is to perform an action or task he may utilize buttons, fields, pull-down menus and other capabilities available in the hot zone.

That is, each portion of the screen is basically a snap-shot of the financial institution and biller's screen portions. To the user, the UI has the look and feel of a singular presentation of information and data entry points. However, Flash MX facilitates the presentation of information from the processor's centralized data base of acquired data from the servers of both the financial institution and billing companies through extraction, transforming and loading (ETL) techniques. The acquisition of data in real-time or through transfer of files, from the two respective servers as needed, thereby significantly reduces acquisition interruptions as perceived by the user and eliminating time-out interruptions by the financial institution and biller's servers. An additional advantage is improved security o f the user's data and improved protection of the user's privacy. A significant strength of Flash MX is its ability to interact with the greatest number of middleware solutions, data bases, and data pipelines of any middleware for Web solutions.

Print stream vendors may be utilized to facilitate creating data pipelines to make legacy data available to the system. Dreamweaver MX, also by Macromedia, Inc., may be used for management of the Web site.

It is notable that a user can go directly from the hot zone reviewing bills that are to be paid to an active pay bills screen, as described in more detail herein below. The left-hand portion of the screen, also referred to as the “sell sheet,” allows a biller to, for example: take care of important customer business (e.g., announce service or fee changes); provide timely information about products/services (e.g., announce seasonal sales, enhancements to existing products/services; new services); provide interactivity (e.g., quiz, games, short videos) that is directed to a particular marketing strategy (and not just a static ad). The above functionality is made possible utilizing Flash MX and cannot be accomplished using standard HTML. The sell sheets are expandable into what appears to the user consumer as the biller's “Direct” site. The system also enables the user to easily navigate back to paying bills from a financial institution, or from other services provided by this full “financial wallet” that allows the consumer to receive and interact with all available financial information from one screen.

Further examples of “sell sheet” capabilities include: rotating ads; push/pull ads (e.g., content can be stored on biller end if the biller is to push the ads, alternatively, content can be stored on the EBPP system provider end); biller can set timers for ad delivery; can provide scrolling ads (e.g., text, video, artwork) including large amounts of information in a scrolling format.

At step 306, the user is prompted as to whether the he wants to view his one or more accounts. If the user desires to view his one or more accounts he may select the “accounts” button 608 and thereby proceed to step 308. At step 308 the user may view each account's profile. After the user is done reviewing his accounts at step 308, the user proceeds to step 310. If, at step 306 the user does not desire to view his accounts, then the user may proceed directly to step 310.

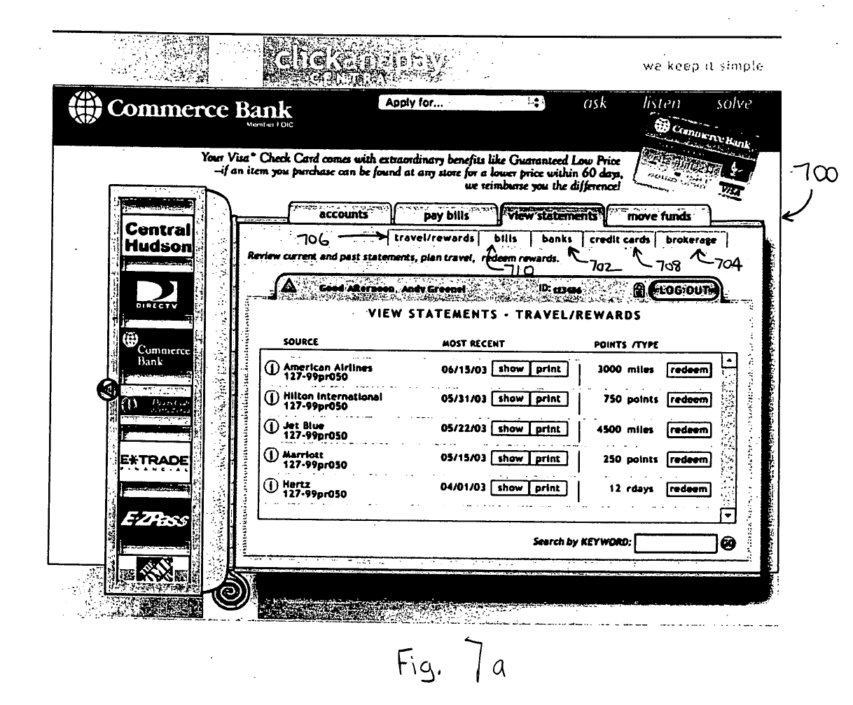

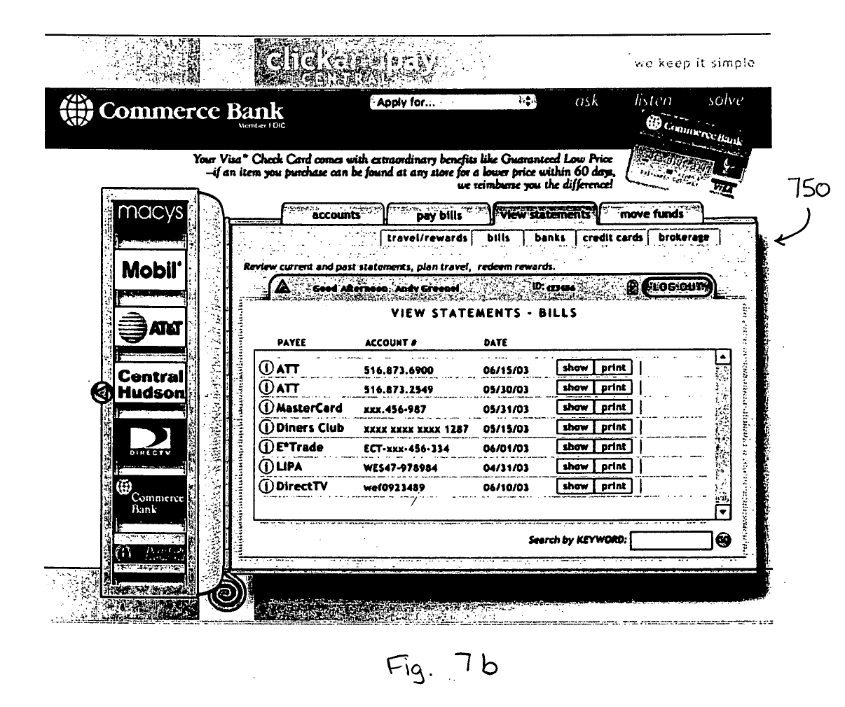

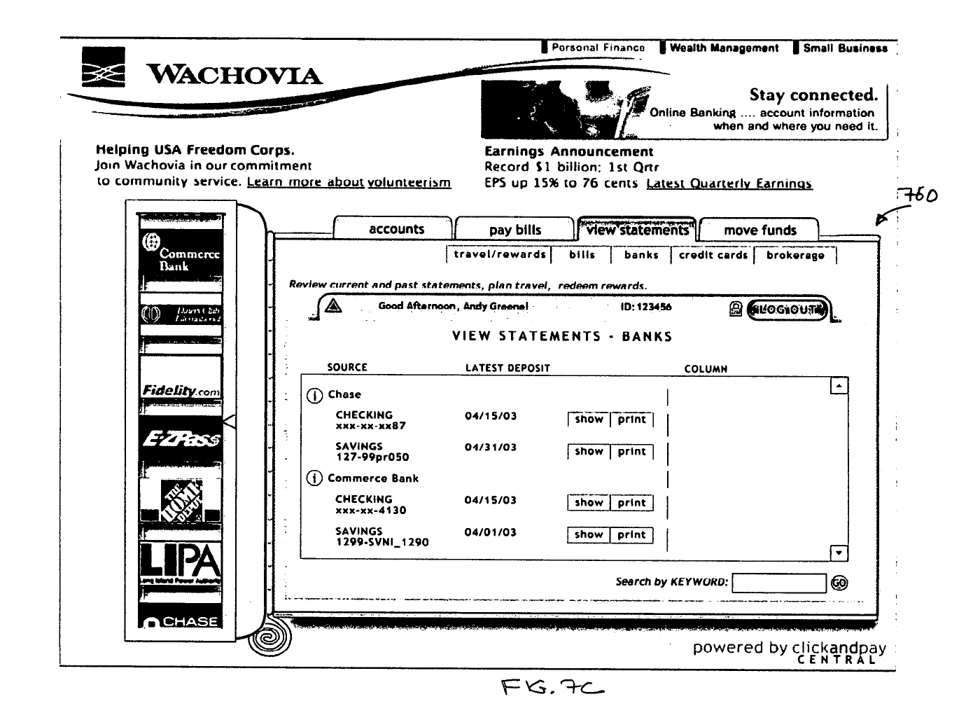

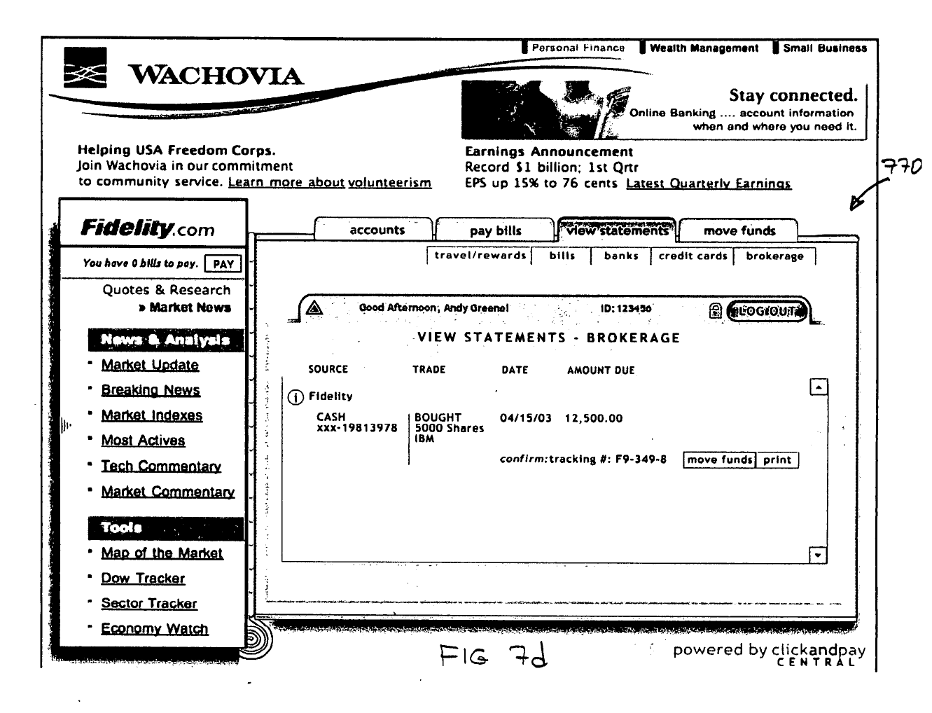

At step 310, the user is prompted as to whether he wants to view his one or more statements. If the user desires to view his one or more statements he may select the “view statements” button 612 and thereby proceed to step 312. At step 312, a statement screen such as statement screen 700 and 750, shown in FIGS. 7a and 7b, respectively, is displayed. Statement screen 700 may include the name and the user's account number with various providers. The providers may include banks, brokerage firms, travel companies (e.g., airlines, hotels, car rental companies), etc. Buttons may be provided to separately access the statements of “banks” 702, “brokerage” firms 704, “travel/rewards” 706, “credit cards” 708, or “bills” 710. In statement screen 700, the “travel/rewards” button 706 was clicked so all such travel/rewards are shown. An example of “banks” view statement 760 is shown FIG. 7c while screen 770 shows “brokerage” statement in FIG. 7d.

By clicking on a provider's name or icon, the user can open the statement for that particular provider. Once a user has selected a provider, a screen (not shown) is displayed showing the user's statement from that provider and allowing the user to perform certain transactions. For example, in a display screen showing a user's bank statement the user may transfer funds; in a display screen showing a user's airline travel rewards statement the user may apply travel rewards to an airline ticket; in a display screen showing a user's brokerage statement the user may transfer funds from a brokerage savings account to an investment in particular stock. After the user is done reviewing his statements at step 312, the user proceeds to step 314. It at step 310 the user does not desire to view his statements, then the user may proceed directly to step 314.

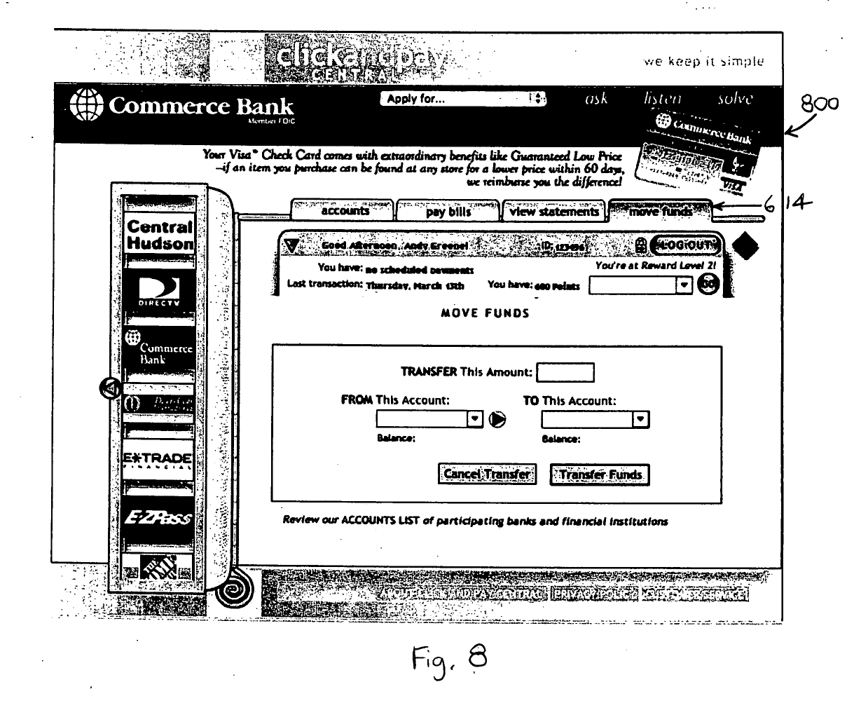

At step 314, the user is prompted as to whether he desires to move funds from one account to another account. If the user desires to move funds he may select the “move funds” button 614 and thereby proceed to step 316. At step 316, a move funds screen such as move funds screen 800 shown in FIG. 8 is displayed. The move funds screen 800 may enable the user to check account balances of his various accounts and move funds between such accounts. After the user is done moving funds at step 316, the user proceeds to step 318. It at step 314 the user does not desire to move funds, then the user may proceed directly to step 318.

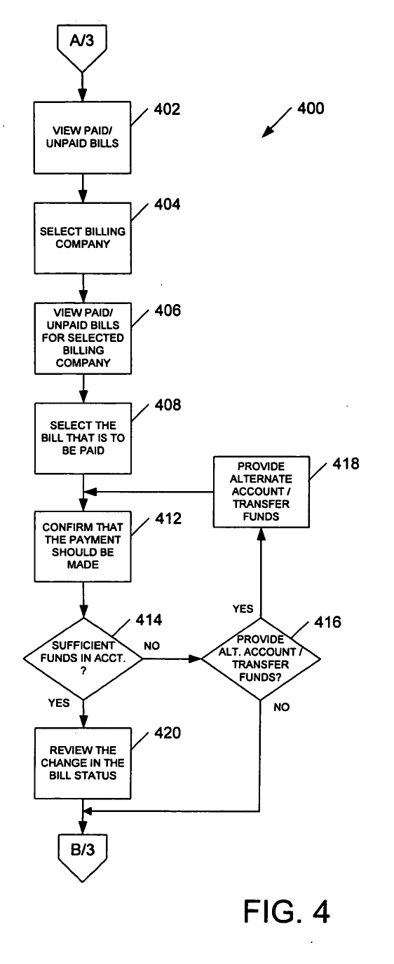

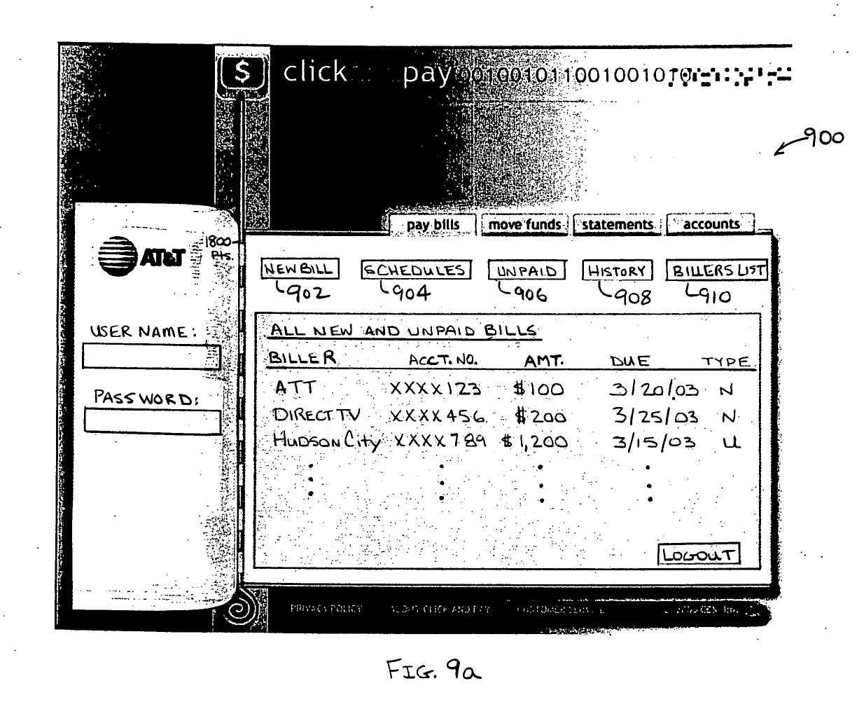

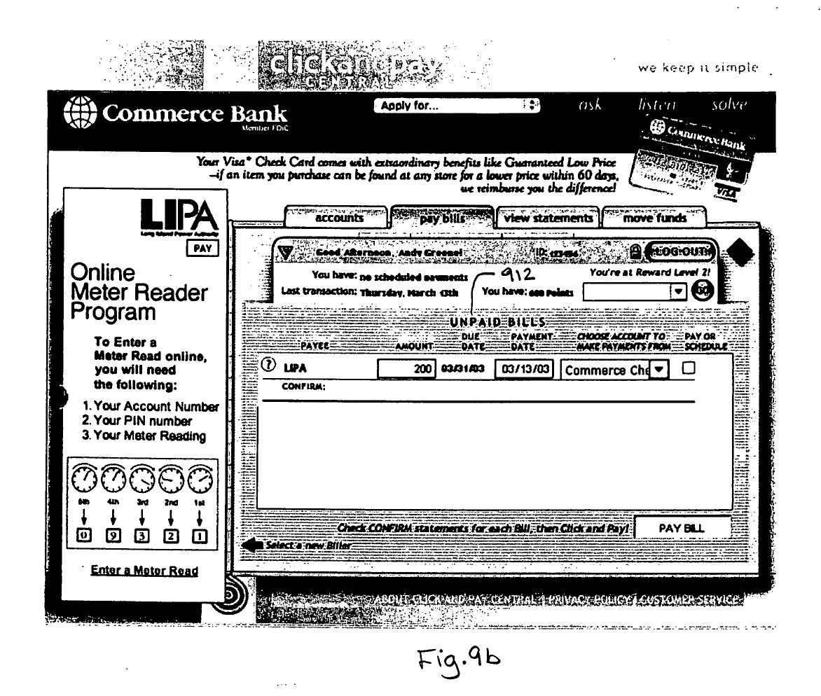

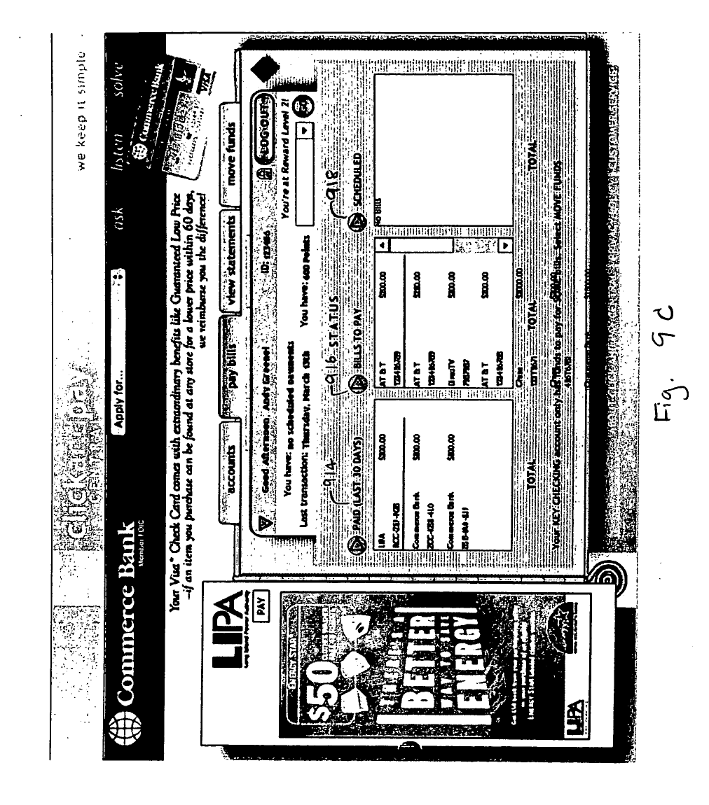

At step 318, the user is prompted as to whether he desires to view and pay bills. If the user desires to view and pay bills he may select the “pay bills” button 610 and thereby proceed to step 402 of flow diagram 400 shown in FIG. 4. At step 402, a default screen such as the default screen 900 shown in FIG. 9 is displayed. There are generally three steps to take when paying a bill. First, the user selects a biller that is to be paid. Second, the user selects a bill that is to be. And third, the user pays the selected bill. The system enables the user to carry out the three general steps in a variety of ways, thereby providing maximum flexibility to the user.

More particularly, for example, a user may view bill statements and select one or more related bills for payment, a user may view the status of bills to be paid and select one or more bills for payment, a user may select a biller from the scrolling icons to pull up the sell sheet of the biller in the left-hand portion of the screen and select one or more bills thereafter from the center portion (ledger area) of the screen. Or, a user can select to open up the sell sheet to expose a full “Biller Direct” application and select one or more of the various biller products and services being offered the consumer from the one screen. It is notable that regardless of the method used to initiate the bill paying process, the sell sheet of the bill will pull up in the left-hand portion of the screen and will open up to a full screen application with one click by the user. Further details regarding the various bill payment initiation methods is described herein and/or shown in the accompanying figures. A significant aspect of the invention is that a minimal number of screens are used for bill payment. That is, while prior art bill payment systems require users to use a minimum of five screens to pay a bill, the present invention basically requires only a single screen for bill payment. An exception to single-screen payment with the present system is when the user's account has insufficient funds. Consequently, this makes the EBPP system disclosed herein significantly more efficient and more user friendly than prior art systems.

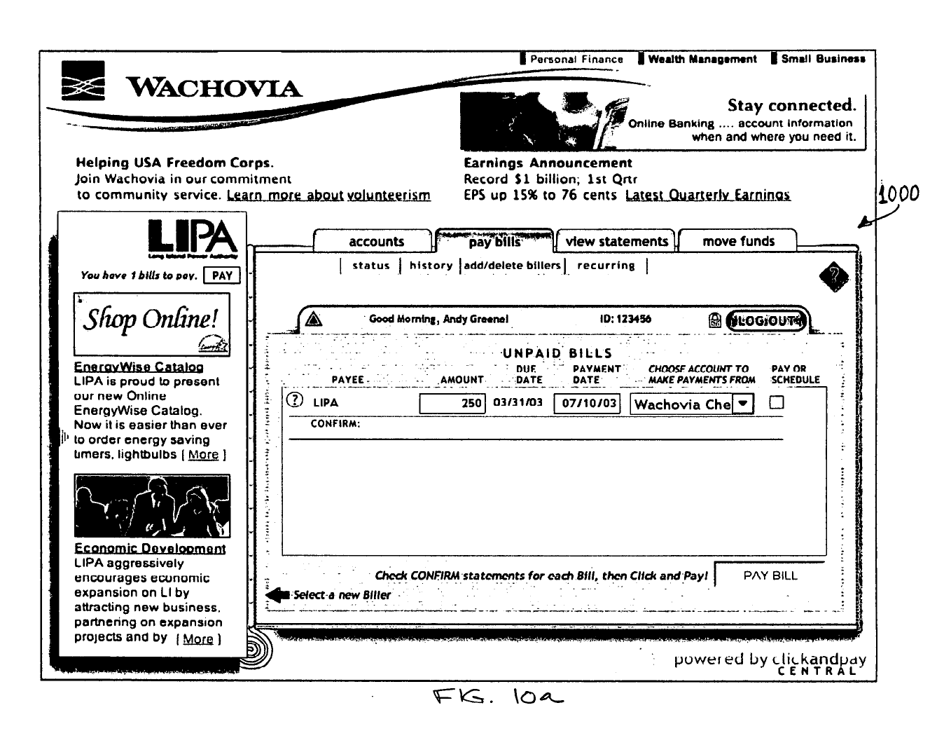

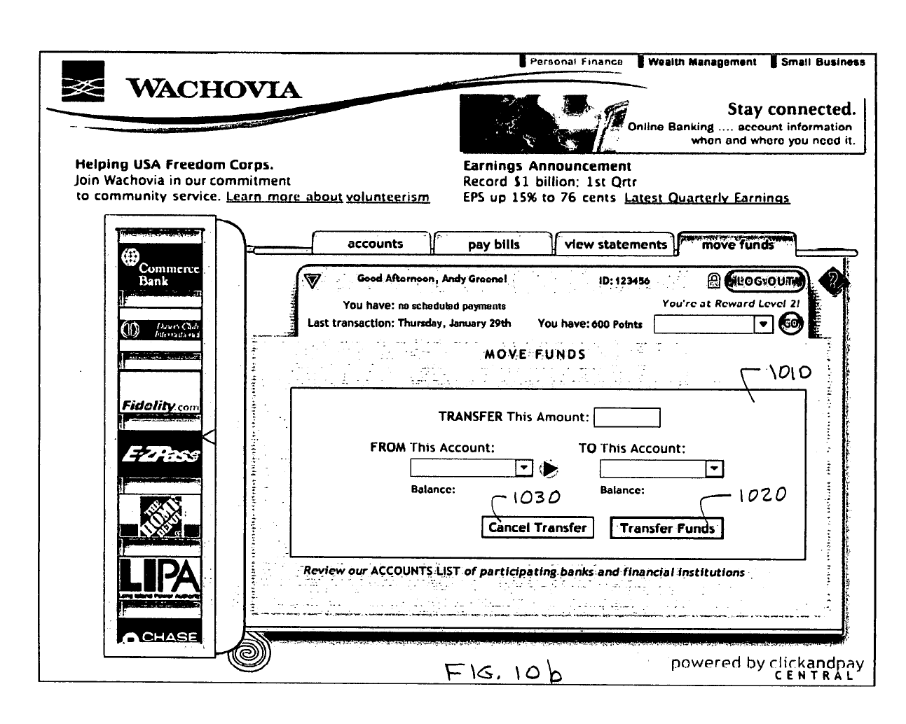

The default screen 900 may immediately display “all new and unpaid bills”, as shown in FIG. 9a, where “new bills” are bills that became available for viewing since the last time the user logged in, and “unpaid bills” are bills that the user has viewed already but are still unpaid. The default screen 900 may also display a “new bill” button 902, “schedules” button 904, “unpaid” bills button 906, “history” button 908, and a “billers list” button 910, as shown in the same Figure. FIG. 9b shows all unpaid bills 912, if any. Under the “pay bills”, status 914 of paid bills, bills to pay 916 and schedule 918 can also be shown, as seen in FIG. 9c. By clicking on the “new bills” button 902 the central panel may display all new bills only. By clicking on the “schedules” button 904 the central panel may display all bills that are scheduled for payment. FIG. 10a shows an exemplary screen 1000 that may be displayed after a user clicks on “schedules” button 904. By clicking on the “unpaid” bills button 906 the central panel may display all unpaid bills only. If there are insufficient funds in a particular account for paying an unpaid bill, then an error window 1010 appears as shown in FIG. 1b. Proper transfer 1020 may be made from one account to another, if available, to pay the bill. Otherwise, the transaction can be cancelled by clicking button 1030, as shown in the same Figure. By clicking on the “history” button 908 in FIG. 6a, the central panel may display all past bills that have been paid. Conveniently, past bills are retained in the system for a period of time (e.g., one year) to enable the user to compare bills over such time period. By clicking on the “billers list” button 910 the lower panel may display all billers and their data. Options may be provided for adding billers, deleting billers, and editing biller information. The default screen may alternatively be as shown in FIG. 6a, wherein the hot zone of the ledger is partitioned into three areas, i.e., “paid” bills, “bills to pay,” and “scheduled” bills.

At step 404, the user selects a biller that is to be paid. As noted above, there are variety of ways a user may select a biller, and thereafter a bill to be paid. A user may click directly on the biller's icon in the left hand panel. A scroll bar may be provided to access billers' icons that do not appear in the left-hand portion of the screen. If the user clicks on a biller's icon, the left-hand portion of the screen may display the selected biller's branding, marketing messages, links, messages, and a login message. FIG. 11 shows an exemplary screen 1100 that may be displayed after a user clicks on the AT&T icon in the left-hand panel of screen 900. It is notable that although the user perceives that he is directly linked to the AT&T server, the user actually continues to interface with the EBPP system and communicates with the AT&T server through the EBPP system.

The user may then display the exemplary screen 1100 shown in FIG. 11. Screen 1100 includes AT&T's branding and marketing messages in the left-hand portion of the screen and only unpaid AT&T bills in the central portion of the screen. Advantageously, such branding and marketing messages (e.g., product/service promotional messages) can be updated by the biller. The billing data is a summary of the data provided on the actual bills, thereby significantly simplifying the bill-paying process for the user as only the essential information for paying bills is shown. It is notable that the “new bills” button 1106, “schedules” button 1108, “unpaid bills” button 1110, and “history” button 1112 may now be used to show the new bills, schedules, unpaid bills (as shown), and history for AT&T billing data only.

At step 408, the user selects a bill that is to be paid. As noted above, there are a number of ways in which a user can select a biller and the bill that is to be paid. Screen 1100 enables a user to directly select to pay one or more bills 1114. In the exemplary screen, the user selected to pay a $300 AT&T bill only. Once one or more bills are selected, the user may have the bill paid from an account that was previously established as a default account or, by using pull-down screens 1116, selecting a particular account from which funds are to be withdrawn to pay the selected bill(s). In the exemplary screen 1100 a “Key Checking” account is the default account that will be used to pay the selected bill. Once the user identifies the one or more bills that are to be paid, the system instructs the financial institution to pay the one or more bills. Thereafter, the financial institution carries out the one or more transactions. Advantageously, the disclosed EBPP system avoids the need to comply with various on-line banking regulations that competitive systems have to comply with.

As noted above, bills that are to be paid may be selected for payment in alternative ways. For example, referring to screen 900, a user may directly click on a bill listed as a new or unpaid bill. As a further example, a user may directly click on a bill that is listed as a bill scheduled for payment. In both examples, the left-hand portion of the screen may display the selected biller's branding, marketing messages, links, and messages. At such point, the user would proceed as described above with respect to step 406 et seq. to pay the bill.

At step 412, once one or more bills have been selected for payment, the user may select the “pay bill” button 1118. The one or more bills will be paid out of the default account unless another account was selected by the user. At step 414, if there are insufficient funds in the account from which funds are to be withdrawn, then, at step 416, the user is prompted to provide an alternate account to transfer funds to the account having insufficient funds. The prompt may be as shown in FIG. 10b, indicating that there is an error (i.e., insufficient funds) and prompting the user to complete the transfer of funds before proceeding. At step 418, the user follows the prompts by providing an alternate account or transfers finds to the account having insufficient funds. Thereafter the user proceeds to step 412 and proceeds as described above. If the user decides that he does not want to provide an alternate account or transfer funds, then the user may proceed to step 320 and log out. Of course, as at other points in the present system a user may take other actions such as return to the main menu and attempt to pay other bills. That is, the steps depicted herein are just one embodiment of the invention and not meant to limit the flexibility of the system.

If at step 414 it is determined that there are sufficient funds in the user's account from which the funds are to be withdrawn, then the system would proceed to step 420. At step 420, the user may review the change in the status of the bills that have been paid by, for example, returning to the main menu 900 and reviewing the “Paid?” column to verify that it reads “Yes” in the line corresponding to the bill just paid. Alternative screen 600 allows a user to review the status of a payment by reviewing the “paid (last 30 days)” box.

As an approved entity, the EBPP provider is authorized to direct the financial institution to pay a bill. Upon receiving instructions from a user to pay a bill, the provider posts the bill with the appropriate financial institution for payment. The bank may pay bills in any number of standardized ways (e.g., via ACH, mutual partnership agreements between participating banks).

As noted above, the EBPP system automatically recognizes the u ser when that user logs on. Therefore, for example, if a user logs on for a business, then the system will be configured accordingly. Many of the functionalities provided to all user, regardless if the user is a business or a consumer. For example, the system may provide dispute resolution functions useful for rectifying billing disputes. Utilizing such a function, a user may be provided a form in which he could indicate the dispute and automatically transmit the form to a biller.

The system utilizes an automated dispute resolution methodology. Upon presentation of an electronic invoice to a user, the system can automatically compare specific biller invoice details to a user's receiving and purchase order documents. This allows the system to automatic ally determine any differences between what the biller billed and what the payer ordered and/or received and create a turnaround document informing the biller of the differences. For example, assume a biller invoiced an item at $2.00 a unit for 10 units. However, the payer's applicable receiving document and purchase order indicate the payer expected to pay $1.75 a unit and that only 9 units were received. The system will automatically determine both price and quantity differences, adjust the invoice line item amount due accordingly, and transmit to the biller the information required for the biller to change their records to bring them into agreement with the payer's. As a further example, if a user buys 100 items and he should have received a 10% price break due to a purchasing agreement, the system will automatically evaluate the bill and flag the bill if the price break is inadvertently not included. The system will also build a history file of these transactions that can be analyzed to determine if the billing errors are random, or if the biller is deliberately billing in error.

The system may provide importing functions for importing billing/payment information directly from the EBPP system to a tax program such as TurboTax by Intuit, Inc. (Mountain View, Calif.) or to a third-party tax advisor.

The system may provide fraud detection functions such as those provided by eFalcon of HNC Software, Inc. (San Diego, Calif.), a leading real-time payment fraud detection service.

The user can look at the types of things purchased by a business to determine if the business is heading toward bankruptcy. For example, a cash-strapped company will tend to purchase more “quick turnover products” than “long turnover products.”

The system may use an artificial intelligence based conversion software that is able to read biller or payer bill/statement/invoice/purchase order/receiving document preparation software and extract the business rules developed by the biller or payer that determine the structure of the printed document. The biller or payer data is stored in a standardized database, independent of the extracted business rules. The business rules are stored in an adjunct database. This procedure allows the system to use the same database structure for all users. It also significantly reduces the time and cost required to convert a new user.

The system may duplicate biller/payer output for either printed or electronic presentation, as required. An advantage lies in the ability to easily change the business rules without affecting the data. It is also possible to determine the effect of a rule change by back testing it against previously stored data and comparing the different outputs to each other. Also using a uniform database allows the system to use advanced data mining techniques across its entire database (within and between all users).

The nature of the biller and payer data stored in the systems database, as a result of the system's bill and invoice presentment and settlement processing, allows a myriad of analytical services to both billers and payers. It should be noted that depending upon the type of analytics required, billers or payers may request various analyses to be run in batch mode with the report delivered, sometime later, over the Internet or run interactively with the biller or payer entering certain required data, online, upon a system request and the report produced and available while the user is still online.

The system can determine within a stated confidence level how much of the billers accounts receivable is unlikely to be collected over a specified time horizon. For example, after a value-at-risk (“VAR”) analysis is completed a statement similar to the following would be made: We are 95% confident that the accounts receivable portfolio collection percent, over the coming six months, will not be less than 82.78%. Based on the portfolio value of $25 million the VAR=(100%−82.78%) ×$25,000,000 =$4,305,000.

The system may also perform a purchasing pattern analysis. If the biller provides certain inventory class information, the system can determine whether the payer (purchaser) has significantly changed their purchasing pattern. A change that would be red flagged would be for the purchaser to discontinue buying across a product line to only acquiring fast-moving items. A buying change of this nature, in an account, can signify that the payer is having cash flow problems, in particular if they are the only customer that has made such a purchasing pattern change. Additionally, purchase pattern analysis may provide a biller with a guide as to the order to present any online promotions or specials to the payer such that the probability of the payer accepting, i.e., clicking on the promotion, is maximized.

The system may also perform a customer payment tracking analysis. The system can provide a biller with a comparative analysis of their customer payments over time and, thereby, help the biller to determine whether their risk of doing business with any specific customer is changing at a rate that indicates a potential credit problem with that customer sometime in the future.

The system may also evaluate credit department operations. The database contains both billing and payment data. Therefore, the system can utilize a discounted cash flow (“DCF”) analysis to determine the maximum DCF of a given invoice versus the realized DCF of the invoice. If information is provided as to the salesman on each account or the credit analyst responsible it is possible to rank each individual in either the credit department or the sales department as to their performance, using an unbiased measure, compared to DSQ or total sales which don't take into account the time value of money.

The system may perform cash flow forecasting. The database, for a given biller, will contain multiple months of billing and payment activity by customer. The system will analyze this data for its billers, and develop a cash flow forecast for a specified time horizon based upon a statistical analysis of past performance and the biller's estimated sales forecast over the specified time period.

The system may perform fraud detection. Another by-product of analyzing the payer's purchasing pattern is fraud detection. If there is a significant variation from the payer's normal purchasing pattern with a specific biller, the system will alert the payer that there may be invoiced items that the payer did not order or receive. This would be for payers that have not contracted with the system to convert its vendors to use the business invoice electronic presentation system.

The system may perform a cash requirements analysis. The system can analyze the payers unpaid invoice file and its outstanding purchase order file, and based upon an analysis of the payers past performance develop a monthly cash requirements analysis over a specified time horizon.

From the detailed description provided above it should be readily apparent to those of ordinary skill in the art that the present invention is a significant improvement over prior art EBPP systems. An EBPP system and method is disclosed that enables a user to specify preferred financial institutions and billers with which the user does business and makes them accessible on a single Web site. In addition, a system and method is disclosed that enables the financial institution to present identification and targeted product/services promotional material and billers to present identification and targeted production/services promotional materials and billing data on the Web site. Furthermore, the system and methods disclosed provide significantly enhanced security and privacy for users' information.

Although the present invention has been described in detail with respect to certain embodiments and examples, variations and modifications exist which are within the scope of the present invention.

What is claimed is:

1. A system for electronic bill presentation and payment (“EBPP”), comprising:
a memory for storing Web pages for an EBPP Web site; and
a processor in communication with the memory, wherein the processor is operative to
(i) receive an EBPP user interface (“UI”) from an EBPP host, the UI configured to display financial institution information in a first portion of the UI, configured to display billing party information in a second portion of the UI, and configured to display billing data in a third portion of the UI,
(ii) receive the financial institution information for display in the first portion of the UI,
(iii) transmit a request for the billing party information and billing data,
(iv) receive the billing party information for display in the second portion of the UI and the billing data identifying one or more bills for display in the third portion of the UI,
(v) transmit instructions to the EBPP host to have one or more bills of the billing party paid, and
(vi) transmit payment information to the billing company.

2. The system of claim 1, wherein the financial institution information comprises product/service promotional information of the financial institution.

3. The system of claim 1, wherein the billing party information comprises product/service promotional information, messages, and links.

4. The system of claim 1, wherein the UI content resides on Macromedia Flash and other Macromedia product lines.

5. The system of claim 1, wherein the EBPP system includes business-to-business components and business-to-consumer components.

6. The system of claim 1, wherein the processor serves both businesses and consumers.

7. The system of claim 1, wherein the processor retrieves from a centralized data base, data acquired from servers of both financial institutions and billing companies, to present financial institution information, biller information, and presenter information on a single Web page.

8. A method for utilizing an electronic bill presentation and payment (“EBPP”) system, comprising:
receiving an EBPP user interface (“UI”) from an EBPP host, the UI configured to display financial institution information in a first portion of the UI, configured to display billing party information in a second portion of the UI, and configured to display billing data in a third portion of the UI;
receiving the financial institution information for display in the first portion of the UI;
transmitting a request for the billing party information and billing data;
receiving the billing party information for display in the second portion of the UI and the billing data identifying one or more bills for display in the third portion of the UI; and
transmitting instructions to the EBPP host to have one or more bills of the billing party paid and transmitting payment information back to the billing company or bank.

9. The method of claim 8, wherein the financial institution information is identification as and product/service promotional information of the financial institution.

10. The method of claim 8, wherein the billing party information is product/service promotional information, messages, and links.

11. The method of claim 8, wherein the UI content is developed using Macromedia Flash and other Macromedia product lines.

12. The method of claim 8, wherein the financial institution controls the content of the financial institution information and the billing party controls of the content of the billing party information.

13. The method of claim 8, wherein the financial institution and billing party are pre-selected by the user.
